(19) United States
(12) Patent Application Publication
(10) Pub. No.: US 2020/0369158 A1
(43) Pub. Date: Nov. 26, 2020

(54) METHOD FOR CONTROLLING A HYDRAULIC BRAKE SYSTEM DURING A REGENERATIVE BRAKING PROCESS, HYDRAULIC BRAKE SYSTEM, COMPUTER PROGRAM PRODUCT, CONTROL UNIT AND MOTOR VEHICLE

(71) Applicant: ZF Active Safety GmbH, Koblenz (DE)

(72) Inventor: Andreas Marx, Hartenfels (DE)

(73) Assignee: ZF Active Safety GmbH, Koblenz (DE)

(21) Appl. No.: 16/881,248

(22) Filed: May 22, 2020

(30) Foreign Application Priority Data
May 23, 2019 (DE) 102019113755.1

(51) Int. Cl. B60L 7/26; B60T 13/58; B60T 8/17; B60T 8/176

(52) U.S. Cl. CPC B60L 7/26; B60T 13/586; B60T 8/17; B60T 2270/10; B60T 2270/604; B60T 2270/602; B60T 8/176

(57) ABSTRACT

A method for controlling a hydraulic brake system where a hydraulic fluid is displaced in the direction of at least two-wheel brakes by means of a brake cylinder. One of the at least two-wheel brakes is at least partially hydraulically isolated from the brake cylinder in order to adapt the at least two-wheel brakes with regard to their hydraulic braking force to an incipient or present wheel load distribution. In addition or alternatively, in the method, it is furthermore the case that at least one volume fraction of the hydraulic fluid is displaced between the at least two wheel brakes in order to adapt the at least two wheel brakes with regard to their hydraulic braking force to a changing wheel load distribution over the course of the braking process and/or to a changing generator braking torque over the course of the braking process.

### CROSS-REFERENCE TO RELATED APPLICATION

This application claims priority to German Patent Application No. 102019113755.1 filed May 23, 2019, the disclosure of which is incorporated herein by reference in its entirety.

### TECHNICAL FIELD

The present disclosure relates to a method for controlling a hydraulic brake system during a regenerative braking process. The present disclosure furthermore relates to a hydraulic brake system. The present disclosure furthermore relates to a computer program product, a control unit and a motor vehicle.

### BACKGROUND

Hydraulic brake systems are used for example in motor vehicles and serve primarily as a service brake for the motor vehicle. A braking operation is commonly performed by virtue of the driver of the motor vehicle actuating a brake pedal and a hydraulic fluid thus being displaced from a brake cylinder to at least one wheel brake, such that, at the wheel brake, a braking force prevails which acts on an associated vehicle wheel. This hydraulic braking force effected by means of the hydraulic fluid commonly corresponds to a braking force demand which is imparted by the driver through the actuation of the brake pedal.

Modern motor vehicles with a hydraulic brake system increasingly have a regenerative braking function in the following manner: In the presence of a braking demand input through actuation of the brake pedal, an electric machine operating in the generator mode is at least temporarily driven by the kinetic energy of the motor vehicle and supplies electrical energy, which can be utilized for example for charging an electrical energy store of the motor vehicle. The electric machine used for this purpose is commonly the electric machine which forms an electric drive for the motor vehicle, for example as a main drive or secondary drive, and which is operated as a generator during the course of an occurring regenerative braking process.

The generator operation of the electric machine is however associated with a drag torque which originates from the electric machine and which exerts a braking action on the motor vehicle. This braking action caused by the electric machine, hereinafter also referred to as generator braking action or generator braking torque, must be taken into consideration in the dimensioning of the hydraulic braking force to be applied in order to meet a braking force demand input by the driver through actuation of the brake pedal. One possible concept in this regard is described in WO 2014/082885 A1.

The document discloses a method for controlling a hydraulic brake system during a regenerative braking process. In the method, at least one volume fraction of a hydraulic fluid which is displaced from a brake cylinder in the direction of a wheel brake is temporarily stored in a hydraulic accumulator via a pressure dissipation valve. It is made possible in this way that, in the case of a predefined braking demand and an associated displacement of the hydraulic fluid, a hydraulic braking action on the wheel brake is omitted at least to the extent that the electric machine can be incorporated for the purposes of generating electrical energy and, despite the generator braking action originating from the electric machine, the resulting overall braking action corresponds to the input braking demand.

### SUMMARY

It is an object of the present disclosure to propose at least one possibility for improving the previous concept of a regenerative braking operation.

The object is achieved by means of a method which has the features of claim 1. The object is furthermore achieved by means of a method which has the features of claim 2. The object is furthermore achieved by means of a hydraulic brake system which has the features of claim 7. Furthermore, to achieve the object, a computer program product having the features of claim 12, a control unit having the features of claim 13 and a motor vehicle having the features of claim 14 are proposed. Advantageous embodiments and/or refinements and/or aspects of the present disclosure will emerge from the subclaims, from the following description and from the figures.

An underlying method for controlling a hydraulic brake system, for example of a motor vehicle, during a regenerative braking process comprises the step whereby a hydraulic fluid, in particular a brake fluid, is displaced or has been displaced in the direction of at least two wheel brakes of the hydraulic brake system by means of a brake cylinder of the hydraulic brake system. In particular, the brake cylinder is a common brake cylinder for the at least two wheel brakes. In particular, the at least two wheel brakes are assigned to in each case one vehicle wheel or are configured to be assigned to one vehicle wheel. In particular, the displacement of the hydraulic fluid implies a braking force demand, in particular a present braking force demand. For example, the displacement of the hydraulic fluid is caused directly or indirectly by means of an actuation of a brake pedal or of some other actuating device. For example, the displacement of the hydraulic fluid corresponds to a braking force demand, in particular present braking force demand, input by means of the brake pedal or the actuating device. For example, the actuation is performed by the driver of the motor vehicle.

The expression “regenerative braking process” is to be understood in the present description to mean in particular a braking process in which, by means of at least one electric machine operated as a generator, kinetic energy is converted into electrical energy and this simultaneously results in a braking action, in particular a braking action which brakes the motor vehicle, which will hereinafter also be referred to as generator braking force or generator braking torque. This braking action is effected for example by a drag torque originating from the electric machine. For example, the kinetic energy results from the movement of the motor vehicle and/or from the rotational movement of the vehicle wheels. The electrical energy is preferably at least partially reused. For example, at least a part of the electrical energy is stored in an electrical energy store and is then available for use, for example for driving the motor vehicle and/or for the on-board electrical system of the motor vehicle.

The displacement of the hydraulic fluid preferably results in a pressure build-up in the at least two wheel brakes, which thus each exert a hydraulic braking force. In one embodiment, the method now comprises the step whereby at least one volume fraction of the hydraulic fluid is displaced, in particular displaced in metered fashion, between the at least two wheel brakes. In this way, a measure is implemented for varying, for example increasing or reducing, the hydraulic braking force exerted by the respective wheel brake. In particular, the hydraulic braking force of the at least two wheel brakes is varied in a mutually corresponding manner, that is to say the hydraulic braking force of one wheel brake is increased and the hydraulic braking force of the other wheel brake is correspondingly or substantially correspondingly reduced.

In particular, in this way, the at least two wheel brakes are to be adapted with regard to their hydraulic braking force to a, for example speed-dependently and/or time-dependently, changing wheel load distribution over the course of the braking process, in particular dynamic wheel load distribution, and/or to a changing generator braking torque over the course of the braking process. The expression “speed-dependently” is to be understood in particular to mean “in a manner dependent on the speed of the motor vehicle”, because, over a certain range of the speed, the generator breaking torque increases with decreasing speed of the braking motor vehicle.

For example, the at least one volume fraction of the hydraulic fluid is displaced, in particular displaced in metered fashion, between the at least two wheel brakes in a manner dependent on a, for example speed-dependently and/or time-dependently, changing wheel load distribution over the course of the braking process, in particular dynamic wheel load distribution, and/or to a changing generator over the course of the braking process. In this way, a reduction or increase of an overall braking torque acting on the motor vehicle can be achieved in the motor vehicle. Basically, the displacement of the at least one volume fraction of the hydraulic fluid between the at least two wheel brakes may take place to such an extent that one of the at least two wheel brakes no longer exerts a hydraulic braking force, or substantially no longer exerts a hydraulic braking force.

In the present description, the expression “wheel load distribution” is to be understood in particular to mean that, during a braking process and/or during a cornering maneuver of the motor vehicle, the center of gravity of the motor vehicle has shifted and thus, for example, a changed wheel load, that is to say a changed action of force on the respective vehicle wheel, is present in relation to the standstill situation of the motor vehicle. In the present description, the expression “dynamic wheel load distribution” is to be understood in particular to mean that the wheel load distribution changes over the course of the braking process or over the course of the cornering maneuver.

In a further or other embodiment, the method comprises the step whereby one of the at least two wheel brakes is at least partially hydraulically isolated from the brake cylinder, that is to say in particular in relation to the brake cylinder. In this way, a measure is implemented whereby the hydraulic braking force effected by the displacement of the hydraulic fluid is different at the at least two wheel brakes, that is to say the at least two wheel brakes exert mutually different hydraulic braking forces. In particular, by means of the at least partial hydraulic isolation of the one wheel brake, an increase of the hydraulic brake force that builds up at the other wheel brake, that is to say at the hydraulically non-isolated wheel brake, is effected in relation to a state without such hydraulic isolation of the one wheel brake. In particular, an increased hydraulic braking force builds up at the other wheel brake or at the hydraulically non-isolated wheel brake, wherein a correspondingly reduced hydraulic braking force builds up at the at least partially hydraulically isolated wheel brake.

Provision may basically be made whereby the one wheel brake is fully hydraulically isolated. For example, it is then the case that a pressure increase effected by the displacement of the hydraulic fluid acts only at the other wheel brake, which is hydraulically non-isolated. In this way, the other wheel brake then for example exerts a greatest possible hydraulic braking force corresponding to the displacement of the hydraulic fluid. The at least partial hydraulic isolation of the one wheel brake may be performed at a time before the displacement of the hydraulic fluid or at the same time as the displacement of the hydraulic fluid or in the course of or during the displacement of the hydraulic fluid in the direction of the at least two wheel brakes.

In particular, by means of the at least partial hydraulic isolation of the one wheel brake, the at least two wheel brakes are to be adapted and/or set with regard to their hydraulic braking force to an incipient or present wheel load distribution. In this way, a reduction or increase of an overall braking torque acting on the motor vehicle can be achieved in the motor vehicle.

Provision may be made whereby an isolation valve is adjusted in the direction of a closed state in order to at least partially hydraulically isolate the one wheel brake from the brake cylinder. Provision may furthermore be made whereby the isolation valve is adjusted into the closed state in order to hydraulically fully isolate the one wheel brake from the brake cylinder. For example, after an adjustment of the isolation valve in the direction of the closed state, the isolation valve is adjusted in the direction away from the closed state, for example in order to relieve the other of the at least two wheel brakes of load with regard to its hydraulic braking force. This is done for example in order to adapt the at least two wheel brakes with regard to their hydraulic braking force to a dynamic wheel load distribution and/or to a speed-dependently changing generator braking torque over the course of the braking process.

For example, one of the at least two wheel brakes is a front wheel brake and is configured to be assigned to a front vehicle wheel, and the other wheel brake is a rear wheel brake and is configured to be assigned to a rear vehicle wheel. The generator braking torque effected by the electric machine during the regenerative braking process can act on the rear vehicle wheel and/or on the front vehicle wheel. It is also possible for at least two electric machines which can operate as generators to be provided, wherein the generator braking torque of one of the electric machines acts on the rear vehicle wheel and the generator braking torque of the other electric machine acts on the front vehicle wheel.

If the step whereby at least one volume fraction of the hydraulic fluid is displaced between the at least two wheel brakes is performed, provision may be made whereby the at least one volume fraction is displaced from the rear wheel brake in the direction of the front wheel brake or from the rear wheel brake into the front wheel brake. In this way, the changed action of force on the front vehicle wheel in relation to the rear vehicle wheel during a braking process is allowed for. For example, an increase of the hydraulically effected vehicle braking torque, that is to say of the braking torque acting on the motor vehicle, is to be achieved in this way, for example if the braking process is in a braking phase in which a high braking torque is required and/or desired at the front wheel brake. For example, this braking situation is promoted in that the generator braking torque effected by the electric machine during the regenerative braking process acts, in particular acts directly, on the rear vehicle wheel. For example, this is achieved by virtue of the at least one electric machine being connected in terms of drive to the rear vehicle wheel. In particular, no generator braking torque acts on the front vehicle wheel. For example, the front vehicle wheel has no drive connection to the electric machine or to an electric machine in the generator mode.

If the step whereby one of the at least two wheel brakes is at least partially hydraulically isolated from the brake cylinder is performed, the at least partially hydraulically isolated wheel brake may be the rear wheel brake. The displacement of the hydraulic fluid in the direction of the at least two wheel brakes then results in a higher hydraulic braking force at the front wheel brake in relation to the rear wheel brake. For example, an increased hydraulic vehicle braking torque is to be achieved in this way, because a focus is placed on the wheel load distribution of the motor vehicle during a braking process, at least in the initial phase of the braking process. This may be performed to such an extent that the rear wheel brake is fully hydraulically isolated, and thus the rear wheel brake exerts no hydraulic braking force. For example, this braking situation is promoted in that the generator braking torque effected by the electric machine during the regenerative braking process acts, in particular acts directly, on the rear vehicle wheel. For example, this is achieved by virtue of the at least one electric machine being connected in terms of drive to the rear vehicle wheel. In particular, no generator braking torque acts on the front vehicle wheel. For example, the front vehicle wheel has no drive connection to the electric machine or to an electric machine in the generator mode.

The step whereby the rear wheel brake is at least partially hydraulically isolated from the brake cylinder may be followed by the step whereby the at least partial hydraulic isolation of the rear wheel brake is at least partially reversed or eliminated. For this purpose, the above-described isolation valve may be utilized, which for this purpose is adjusted in the direction away from its closed state. In particular, by means of the isolation valve, the throughflow of the at least one volume fraction of the hydraulic fluid to the rear wheel brake is controlled and/or metered. It is possible in this way to allow the hydraulic fluid to also flow into the rear wheel brake, and/or to allow a greater volume fraction of the hydraulic fluid to flow into the rear wheel brake, and to thus promote an equalization of volume of the hydraulic fluid between the front wheel brake and the rear wheel brake. In this way, a reduction of the hydraulically effected vehicle braking torque during the regenerative braking process is to be achieved, for example in order to counteract or compensate a generator-effected vehicle braking torque, originating for example from the at least one electric machine, which increases during the course of the braking process.

An underlying hydraulic brake system, for example for a motor vehicle, in particular for carrying out the method described above, comprises a brake cylinder and at least two wheel brakes, which are each hydraulically connected via a feed line to the brake cylinder. The brake cylinder is configured to displace a hydraulic fluid in the direction of the at least two wheel brakes. The at least two wheel brakes are configured to exert a hydraulic braking force, in particular in each case one hydraulic braking force, by means of the hydraulic fluid. The hydraulic brake system furthermore comprises an isolation valve which is fluidically assigned to one of the feed lines and which is configured to close the one feed line.

Also provided in the hydraulic brake system is a control unit which is connected in signal-exchanging fashion to the isolation valve. In particular, the control unit is configured to activate and/or communicate with the isolation valve. For example, the control unit is furthermore connected in signal-exchanging fashion to at least one electric machine which is utilized during the regenerative braking, such as for example the electric machine described above. In particular, the control unit is configured to control the electric machine and/or communicate with the electric machine. For example, the control unit is furthermore connected in signal-exchanging fashion to an actuating device for actuating the brake cylinder, such as for example a brake pedal or a brake lever, and/or to at least one sensor element assigned to the actuating device, such as for example a travel sensor, in particular a pedal travel sensor, and/or a force sensor, in particular a pedal force sensor.

In particular, the control unit is configured to communicate with the actuating device and/or with the at least one sensor element and/or to receive signals from the actuating device and/or from the at least one sensor element, and to take the signals into consideration with regard to an activation of the isolation valve and/or of the electric machine. The control unit may be in hardware form and/or software form, for example in the form of a computer program or computer program module, or may be a constituent part of an item of hardware and/or an item of software.

According to one embodiment, the control unit is configured to, in the presence or upon an onset of an actuation of the brake cylinder, and in particular in the presence or upon an onset of a generator braking torque of at least one electric machine, such as for example the electric machine described above, activate the isolation valve for adjustment in the direction of a closed state for example in order to at least partially hydraulically isolate the associated wheel brake from the brake cylinder and thus adapt the at least two wheel brakes with regard to their braking force to an incipient or present wheel load distribution. In this way, with regard to the refinement of the control unit, a possibility is proposed for carrying out the above-described method and thus achieving the advantages described with regard to the method.

The “onset of an actuation of the brake cylinder” is to be understood in particular to mean that an actuation of the brake cylinder has not yet taken place or is not yet taking place, that is to say in particular the hydraulic fluid has not yet been or is not yet being displaced in the direction of the at least two wheel brakes, but a preparatory operation has already been performed or is already being performed and/or a braking-relevant state has taken effect, from which a required actuation of the brake cylinder can be derived or is to be derived. In particular, upon the onset of an actuation of the brake cylinder, the at least two wheel brakes do not yet exert a braking force, that is to say no hydraulic braking force has yet been built up by the at least two wheel brakes.

The preparatory operation may be or comprise a light initial depression or light initial touch of an actuating device that is coupled in terms of actuation to the brake cylinder, for example of a brake pedal or of a brake lever. Also, the preparatory operation may comprise or consist in an actuated accelerator/gas pedal being varied in the direction of less gas or an actuation of an accelerator/gas pedal being ended, for example because a subsequent actuation of the actuating device is to be expected. The preparatory operation may be performed by the driver of the motor vehicle or by an adjusting element of a vehicle controller, for example of an automated driving system or autopilot or of a driver assistance system or the like.

The braking-relevant state may be caused by an obstruction in the path of travel of the motor vehicle and/or a departure of the track of the motor vehicle from a predefined traffic lane and/or some other visually and/or acoustically perceptible action on the motor vehicle and/or on the driving behavior thereof or the driving characteristics thereof. The braking-relevant state may be detected by means of at least one sensor element of a vehicle controller, for example of an automated driving system or autopilot or of a driver assistance system or the like. For example, the presence of such a braking-relevant state may be identified by the vehicle controller on the basis of the information items from the at least one sensor element.

The “onset of a generator braking torque of the electric machine” is in particular also to be understood to mean that the electric machine is to be switched into the generator mode, for example by virtue of an electrical energization of the electric machine being withdrawn or switched off. In particular, the electrical energization of the electric machine is withdrawn or switched off in a manner dependent on an actuation of the actuating device which is coupled in terms of actuation to the brake cylinder. For example, the electrical energization of the electric machine is withdrawn or switched off in a manner dependent on an actuation of the accelerator/gas pedal and/or of the brake pedal of the motor vehicle. The actuation of the actuating device or of the accelerator/gas pedal and/or of the brake pedal may be performed by the driver of the motor vehicle or by a vehicle controller, for example an automated driving system or autopilot or a driver assistance system or the like.

The expression “vehicle controller” is to be understood in particular to mean a control system which effects an actuation of the brake cylinder independently of an actuation of the brake pedal performed by the driver. Such a control system, which may also be referred to as automatic vehicle controller, may be a driver assistance system. The driver assistance system is for example a distance-regulating cruise control system (ACC; Adaptive Cruise Control), which performs radar-based closed-loop control of the distance to a vehicle traveling ahead by means of braking and engine interventions, or a driving dynamics regulation system (ESC; Electronic Stability Control), which seeks, through targeted braking of individual wheels of the motor vehicle, to prevent skidding of the motor vehicle in a limit range during cornering both in the case of oversteering and in the case of understeering of the motor vehicle, and thus ensure that the driver has control over the motor vehicle.

According to a further or other embodiment, the control unit is configured to, in the presence of an actuation of the brake cylinder and in particular in the presence of a generator braking torque of the electric machine, activate the isolation valve for adjustment in the direction away from a closed state or the above-described closed state, for example in order to adapt the at least two wheel brakes with regard to their hydraulic braking force to a, for example speed-dependently and/or time-dependently, changing wheel load distribution over the course of the braking process, in particular dynamic wheel load distribution, and/or to a changing generator braking torque over the course of the braking process.

In this way, too, with regard to the refinement of the control unit, a possibility is proposed for carrying out the above-described method and thus achieving the advantages described with regard to the method. This is because, by means of the adjustment of the isolation valve in the direction away from the closed state, an at least partial hydraulic isolation of the one wheel brake is to be at least partially eliminated or reversed, whereby volume compensation at the at least two wheel brakes with regard to the displaced hydraulic fluid is promoted. In this way, in turn, a reduction of the hydraulically effected vehicle braking torque during the regenerative braking process is to be achieved, for example in order to counteract or compensate a generator-effected vehicle braking torque, originating for example from the at least one electric machine, which increases during the course of the braking process. This is the aim, for example, of the measure whereby the control unit is configured to, in the presence of an actuation of the brake cylinder, activate the isolation valve for adjustment in the direction away from the closed state in a manner dependent on a change in the wheel load distribution and/or a changing generator braking torque.

For example, one of the at least two wheel brakes is a front wheel brake and is configured to be assigned to a front vehicle wheel, and the other wheel brake is a rear wheel brake and is configured to be assigned to a rear vehicle wheel. The generator braking torque effected by the electric machine during the regenerative braking process can act on the rear vehicle wheel and/or on the front vehicle wheel. It is also possible for at least two electric machines which can operate as generators to be provided, wherein the generator braking torque of one of the electric machines acts on the rear vehicle wheel and the generator braking torque of the other electric machine acts on the front vehicle wheel.

Provision may be made whereby the isolation valve and/or the control unit are for example a constituent part of an anti-lock braking system (ABS) or of a driving dynamics control system (ESC) of the motor vehicle or for the motor vehicle. This promotes cost advantages, because the components involved then perform a multiple function or a multiple use.

In the present description, the expression “wheel brake” is to be understood in particular to mean a friction brake, such as for example a disk brake or a drum brake. In particular, the wheel brake is configured to be utilized as a service brake. For example, the wheel brake is assigned to a vehicle wheel or is configured to be assigned to a vehicle wheel.

In the present description, the expression “brake cylinder” is to be understood in particular to mean a device which generates fluid pressure. The brake cylinder may comprise a pressure piston which is for example held displaceably in a cylinder and which, by means of a displacement movement of the pressure piston relative to the cylinder, effects a displacement of a hydraulic fluid or of a hydraulic fluid volume. The expression “brake cylinder” in particular also encompasses a conveying pump or similar conveying device as a device which generates fluid pressure. The brake cylinder may be a master brake cylinder. For example, the brake cylinder is a master brake cylinder such as is common in conventional hydraulic brake systems. For example, the brake cylinder comprises a reservoir and/or a replenishment vessel for the hydraulic fluid.

In particular, the brake cylinder interacts with an actuating device, or the brake cylinder is configured to interact with an actuating device. The actuating device may be the actuating device already described above. In particular, an actuation of the actuating device has the effect, at the brake cylinder, that a displacement of the hydraulic fluid occurs. For example, an actuation of the brake cylinder is realized mechanically, in particular purely mechanically, or electrically or electromechanically.

For example, the actuating device comprises a brake pedal or a brake lever which acts, for example via a piston rod, on the brake cylinder so as to generate fluid pressure. In addition or alternatively, the actuating device may comprise an electric machine, in particular an electric motor, wherein an output shaft of the electric machine is coupled in terms of drive to the brake cylinder in order to thereby actuate the brake cylinder. The actuating device may be actuated manually for example by the driver of the motor vehicle or automatically or in self-acting fashion by means of a vehicle controller, for example the vehicle controller described above.

In the present description, the expression “isolation valve” is to be understood in particular to mean a shut-off element by means of which the one wheel brake or the associated wheel brake can be at least partially hydraulically decoupled, that is to say isolated, from the brake cylinder. In particular, the isolation valve is configured to close and open the one feed line or the associated feed line. In particular, the isolation valve is configured to completely close or at least partially close the feed line. For example, the isolation valve has a passage for fluid, in particular the hydraulic fluid, which passage is of variable cross section. For example, the isolation valve is configured to be adjusted between a closed position and an open position, for example with regard to the passage, wherein, in the closed position, the feed line is at least partially or completely closed, that is to say shut off. In the “closed state” described above, the isolation valve is situated for example in the closed position. If the isolation valve is adjusted in a direction away from the closed state, it is for example the case that the cross section of the passage is increased in size. If the isolation valve is adjusted in a direction toward the closed state, it is for example the case that the cross section of the passage is decreased in size.

For example, the isolation valve is configured to be electrically and/or electromagnetically actuated, in particular in order to be adjusted and/or switched, for example adjusted and/or switched in continuously variable or stepped and/or digital or analog fashion, between the closed position and the open position. For example, the isolation valve is or comprises a 2/2 directional valve, which, for example, assumes the open position in a non-actuated state and the closed position in an actuated state. If it is an electrically or electromagnetically actuated isolation valve, it is for example electrically deenergized in the non-actuated state and electrically energized in the actuated state. For example, the isolation valve is a valve with an NO function. The NO function is to be understood in particular to mean that the valve is open in the electrically deenergized state. Such a valve may also be referred to as a “normally open” NO valve. For example, the isolation valve is a preferably directly controlled solenoid valve with an NO function.

In the present description, the expression “control unit” is to be understood in particular to mean an electronic unit of an item of computer hardware which, in conjunction with the hydraulic brake system and for example an electric machine utilized during regenerative braking, controls particular processes and/or sequences. The control unit may have a digital processing unit, which comprises for example a microprocessor unit (CPU). The CPU may be connected in data-exchanging and/or signal-exchanging fashion to a memory system and/or bus system. The control unit may have one or more programs or program modules. The digital processing unit may be designed such that commands that are implemented as a program stored in a memory system are executed, input signals are received from a data bus system, and/or output signals are output to a data bus system. A memory system may have one or more, in particular different, memory media. The memory media may in particular be optical, magnetic, solid-state memory media and/or other, preferably nonvolatile memory media.

According to one aspect, the present disclosure furthermore relates to a computer program product having program code, which is stored on a computer-readable medium, for carrying out an embodiment of the above-described method.

According to a further aspect, the present disclosure relates to a control unit, in particular for the above-described hydraulic brake system, comprising the above-described computer program product.

According to a further aspect of the present disclosure, a motor vehicle having the above-described hydraulic brake system and/or having the above-described computer program product and/or having the above-described control unit is provided.

In one embodiment, the motor vehicle comprises at least one front vehicle wheel and at least one rear vehicle wheel. Furthermore, the motor vehicle comprises at least one electric machine connected in terms of drive to the rear vehicle wheel, which electric machine is configured to be utilized as a generator during a braking process of the motor vehicle. The electric machine may be the electric machine described above.

In particular, the electric machine is configured to be present only in a generator mode or to be switched, in particular manually or automatically switched, into a generator mode upon an onset of a braking process of the motor vehicle, in particular upon an onset of a displacement of the hydraulic fluid by means of the brake cylinder. For example, the electric machine is an electric drive of the motor vehicle, which, for example as a main drive or secondary drive, acts with driving action on the at least one vehicle wheel and, during a braking process of the motor vehicle, is utilized as a generator in order, for example, to charge an electrical energy store of the motor vehicle.

### BRIEF DESCRIPTION OF THE DRAWINGS

Further details and features of the present disclosure will emerge from the following description of two exemplary embodiments on the basis of the drawing. In the drawing:

FIG. 1 shows a possible embodiment of a hydraulic brake system, which is suitable for carrying out a regenerative braking process, in a schematic illustration, and

FIG. 2 shows a further possible embodiment of a hydraulic brake system, which is suitable for carrying out a regenerative braking process, in a schematic illustration.

### DETAILED DESCRIPTION

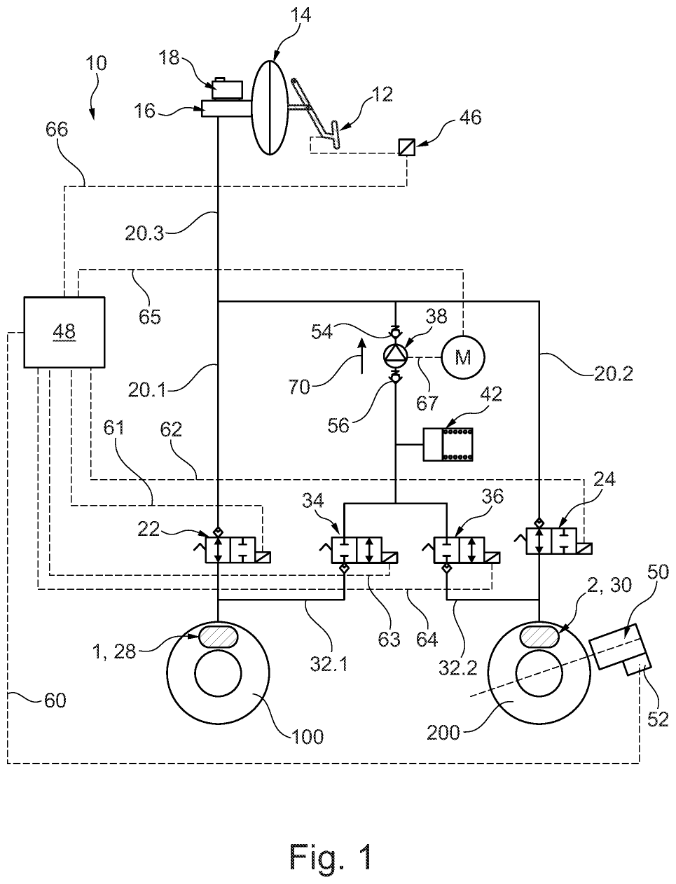

FIG. 1 shows a possible embodiment of a hydraulic brake system 10 which is suitable for being used for example in a motor vehicle, in particular a passenger motor vehicle, a heavy goods vehicle or a motorcycle. In FIG. 1, the hydraulic brake system 10 is illustrated by way of example in conjunction with two vehicle wheels 100, 200. The hydraulic brake system 10 is configured to be able to perform a regenerative braking process. In the regenerative braking process, the kinetic energy of the motor vehicle is utilized in order to drive an electric machine 50 in generator mode and thereby generate electrical energy. The electrical energy can be utilized for example to charge an electrical energy store of the motor vehicle.

By way of example, in FIG. 1, the electric machine 50 is assigned to one of the vehicle wheels 100, 200, in particular to the vehicle wheel 200, in order to illustrate that the electric machine 50 is driven by the movement of the vehicle, that is to say by the rotation of the vehicle wheel 200. The electric machine 50 is preferably a constituent part of an electric drive of the motor vehicle, which serves for example for driving the vehicle wheel 200. During a regenerative braking process, the electric drive is utilized as a generator.

The hydraulic brake system 10 comprises at least one, preferably at least two, wheel brakes 28, 30, which can be assigned to in each case one vehicle wheel. For example, the one wheel brake 28 is are to one vehicle wheel 100, and the other wheel brake 30 to the vehicle wheel 200. For example, the one vehicle wheel 100 is a front wheel, and the other vehicle wheel 200 is a rear wheel. In this respect, the one wheel brake 28 may be a front wheel brake 1, and the other wheel brake 30 may be a rear wheel brake 2.

Preferably, the at least two wheel brakes 28, 30 are each hydraulically connected via a feed line 20.1, 20.2 to a brake cylinder 16. For example, the feed lines 20.1, 20.2 are hydraulically connected via a common line portion 20.3 to the brake cylinder 16. The brake cylinder 16 is configured to displace a hydraulic fluid in the direction of the at least two wheel brakes 28, 30. The at least two wheel brakes 28, 30 are each configured to exert a braking force, for example in the form of a friction force, on the associated vehicle wheel 100 or 200 respectively by means of the hydraulic fluid. The hydraulic brake system 10 is preferably assigned a brake pedal 12, by means of which the brake cylinder 16 is to be actuated. The brake cylinder 16 is preferably assigned a reservoir 18 for the purposes of storing hydraulic fluid for the hydraulic brake system 10 in the reservoir. The reservoir 18 may have an inlet opening in order to be refilled or filled via the inlet opening.

To boost an actuating force input by means of the brake pedal 12, for example by a driver of the motor vehicle, a brake force booster 14 may be provided. The brake force booster 14 preferably boosts the actuating force in a known manner in accordance with a pneumatic, electrohydraulic or electromechanical principle. In order, for automatic vehicle control, to actuate the brake cylinder independently of an actuation of the brake pedal by the driver, it is also possible for an electrically controlled brake force booster (EBB; Electronic Brake Booster) to be provided.

The hydraulic brake system 10 preferably furthermore comprises at least one, for example two, isolation valve(s) 22, 24, of which the one isolation valve 22 is assigned to the one feed line 20.1 and the other isolation valve 24 is assigned to the other feed line 20.2 and which are each configured to close the associated feed line 20.1 or 20.2. For example, it is the intention, by means of the one isolation valve 22, for the one wheel brake 28 to be able to be at least partially or entirely hydraulically isolated from the brake cylinder 16. For example, it is the intention, by means of the other isolation valve 24, for the other wheel brake 30 to be able to be at least partially or entirely hydraulically isolated from the brake cylinder 16.

The isolation valves 22, 24 are preferably each provided for adjustment between a closed position and an open position in order to close or shut off, in particular entirely or at least partially close or shut off, the associated feed line 20.1 or 20.2. Preferably, in the closed position of the respective isolation valve 22 or 24, the associated feed line 20.1 or 20.2 is shut off, in particular fully shut off or at least largely or substantially shut off, and, in the open position, the associated feed line 20.1 or 20.2 is open, in particular substantially open or fully open.

Preferably, the hydraulic brake system 10 furthermore has at least one, for example two, return lines 32.1, 32.2, of which the one return line 32.1 is assigned to the one wheel brake 28 and the other return line 32.2 is assigned to the other wheel brake 30. The return lines 32.1 and 32.2 each serve for returning at least one volume fraction of the hydraulic fluid from a region positioned downstream of the respectively associated isolation valve 22 or 24 into a region positioned upstream of the respectively associated isolation valve 22 or 24. For example, the return lines 32.1 and 32.2 are each connected in terms of flow by way of one end to the associated feed line 20.1 or 20.2 in a region between the associated isolation valve 22 or 24 and the associated wheel brake 28 or 30. Preferably, the return lines 32.1 and 32.2 are connected in terms of flow by way of another end to the associated feed line 20.1 or 20.2 in a region between the associated isolation valve 22 or 24 and the brake cylinder 16. In this way, at least one volume fraction of the hydraulic fluid can be returned from the associated wheel brake 28 or 30 into the respective feed line 20.1 or 20.2, bypassing the associated isolation valve 22 or 24.

The “region positioned downstream” is to be understood in particular to mean that receiving volume of the brake system 10 for receiving hydraulic fluid which is positioned downstream of the isolation valve 22 or 24 under consideration as viewed in the flow direction with respect to the feed line 20.1 or 20.2 under consideration, that is to say in the direction from the brake cylinder 16 to the wheel brake 28 or 30 under consideration. For example, the region positioned downstream comprises a hydraulic receiving volume of the associated feed line 20.1 or 20.2 which is positioned downstream of the isolation valve 22 or 24 under consideration, and/or comprises a hydraulic receiving volume of the wheel brake 28 or 30 under consideration.

The “region positioned upstream” is to be understood in particular to mean that receiving volume of the brake system 10 for receiving hydraulic fluid which is positioned upstream of the isolation valve 22 or 24 under consideration as viewed in the flow direction with respect to the feed line 20.1 or 20.2 under consideration, that is to say in the direction from the brake cylinder 16 to the wheel brake 28 or 30 under consideration. For example, the region positioned upstream comprises a hydraulic receiving volume of the associated feed line 20.1 or 20.2 which is positioned upstream of the isolation valve 22 or 24 under consideration and/or comprises a hydraulic receiving volume of the brake cylinder 16 and/or of the reservoir/replenishment vessel 18 for the hydraulic fluid.

Preferably, the return line 32.1, 32.2 each have a pressure dissipation valve 34 or 36 respectively. Preferably, the return lines 32.1, 32.2 have a common line portion 32.3, which is fluidically assigned a pump 38 and an accumulator 42. The pump 38 is configured to convey at least one volume fraction of the hydraulic oil, in particular in a return direction 70. Preferably, by means of a conveying action of the pump 38 in the return direction 70, the at least one volume fraction of the hydraulic fluid is conveyed in the direction of the region positioned upstream. The accumulator 42 is configured to store at least one volume fraction of the hydraulic fluid, in particular to store the same under pressure, in particular to buffer-store the same.

The respective pressure dissipation valve 34 or 36 is configured to open and close the respectively associated return line 32.1 or 32.2. The respective pressure dissipation valve 34 or 36 is preferably provided for adjustment between a closed position and an open position in order to open, in particular entirely or at least partially open, the associated return line 32.1 or 32.2. Preferably, in the open position of the respective pressure dissipation valve 34 or 36, the associated return line 32.1 or 32.2 is open, in particular at least partially open or fully open, and, in the closed position, the respective return line 32.1 or 32.2 is closed or shut off, in particular entirely shut off or at least largely or substantially shut off. Preferably, as viewed in the return direction 70 of the hydraulic fluid, the respective pressure dissipation valve 34 or 36, the pump 38 and the accumulator 42 are arranged in the sequence in which the respective pressure dissipation valve 34 or 36 comes first, and is followed either by the pump 38 or the accumulator 42. By opening the corresponding return line 32.1 or 32.2, the accumulator 42 is thus filled with the returned volume fraction of the hydraulic fluid.

Preferably, the hydraulic brake system 10 furthermore comprises a control unit 48, in particular an electrical control unit, for activating the isolation valves 22, 24 and/or the pressure dissipation valves 34, 36 and/or the pump 38. For example, for this purpose, the control unit 48 is connected in signal-exchanging fashion to the isolation valves 22, 24 and/or to the pressure dissipation valves 34, 36 and/or to the pump 38 via a corresponding signal line 61 or 62 or 63 or 64 or 65 respectively, in particular electrical signal line. Preferably, the isolation valves 22, 24 and/or the pressure dissipation valves 34, 36 and/or the pump 38 has in each case one electrical receiver unit in order to process the control signals transmitted by the control unit 48 and initiate or perform a corresponding actuation of the isolation valve 22 or 24 or of the pressure dissipation valve 34 or 36 or of the pump 38 respectively.

For example, for this purpose, the pump 38 may have a corresponding actuating device, such as for example an electric drive motor M, which is activated by the control line 65 and which acts on the pump 38, in particular on a working cylinder of the pump 38, via a mechanical and/or hydraulic and/or electromagnetic actuation connection 67. Preferably, both control signals and state signals, for example signals with information items regarding monitored or detected parameters, are to be transmitted via the signal lines 61, 62, 63, 64, 65.

The control unit 48 is preferably connected in signal-exchanging fashion to the electric machine 50 for example via a signal line 60, in order to transmit control signals from the control unit 48 to the electric machine 50 and/or conversely in order to transmit control signals or signals containing information items regarding an operating state of the electric machine 50, for example, to the control unit 48. For this purpose, the electric machine 50 may have a control unit 52 which communicates via the signal line 60 with the control unit 48 and which activates, in particular directly activates, the electric machine 50.

Preferably, the control unit 48 is furthermore connected in signal-exchanging fashion via a signal line 66 to a sensor element assigned to the brake pedal 12, in particular a pedal travel sensor 46. The pedal travel sensor 46 serves for detecting a pedal travel of the brake pedal 12. Via the signal connection between the pedal travel sensor 46 and the control unit 48, the control unit 48 can take into consideration information items relating to the pedal travel.

The control unit 48 is preferably configured such that, in the presence or upon an onset of an actuation of the brake cylinder 16 and in particular in the presence or upon an onset of a generator braking torque originating from the electric machine 50, the control unit activates at least one of the pressure dissipation valves 34, 36 for opening and the associated isolation valve 22 or 24 for adjustment in the direction of a closed state, and furthermore activates the pump 38 for imparting a conveying action. The control unit 48 is preferably also configured such that, in the presence or upon an onset of an actuation of the brake cylinder 16 and in particular in the presence or upon an onset of a generator braking torque originating from the electric machine 50, the control unit activates the two pressure dissipation valves 34, 36 for opening and the two associated isolation valves 22, 24 for adjustment in the direction of a closed state, and furthermore activates the pump 38 for imparting a conveying action. Preferably, the control unit 48 is configured such that, in the presence or upon an onset of an actuation of the brake cylinder 16, and in particular in the presence or upon an onset of a generator braking torque at least one of the pressure dissipation valves 34, 36 is activated for opening, the associated isolation valve 22 or 24 is subsequently or simultaneously activated for closing, and the pump 38 is activated, for imparting a conveying action, subsequently to or simultaneously with the activation of the isolation valve 22 or 24.

In order to identify or detect a presence or an onset of an actuation of the brake cylinder 16, the control unit 48 utilizes, for example, information items from the pedal travel sensor 46. In order to identify or detect a presence of a generator braking torque of the electric machine 50, the control unit 48 utilizes, for example, signals from sensor elements which provide information items relating for example to the operating state of the electric machine 50. In addition or alternatively, it is also possible for the electric machine 50 to be utilized directly, for example by virtue of the control unit 48 using information items from the control unit 52 of the electric machine 50 for this purpose. If the control unit 48 identifies or detects that the electric machine 50 is not operating in the generator mode, for example because the electric machine 50 is still electrically energized, the control unit 48 may be configured to output a control command to the electric machine 50 to switch into the generator mode.

In order to perform a regenerative braking process without or substantially without hydraulic braking force action, the hydraulic brake system 10 may provide the following mode of functioning: An actuation of the brake pedal 12 or an incipient actuation of the brake pedal 12 is identified or detected by the control unit 48. The pressure dissipation valve 34 and/or the pressure dissipation valve 36 is hereupon activated for opening by the control unit 48. This results in an adjustment of the pressure dissipation valve 34 and/or of the pressure dissipation valve 36 from the closed position (FIG. 1) toward its open position and thus an opening of the return line 32.1 and/or of the return line 32.2. As a result of the actuation of the brake pedal 12, a displacement of a hydraulic fluid from the brake cylinder 16 in the direction of the wheel brakes 28, 30 is effected via the feed lines 20.1, 20.2. Owing to the opened return line 32.1 and/or the opened return line 32.2, at least one volume fraction of the hydraulic fluid is conducted into the accumulator 42, such that a hydraulic braking force corresponding to the displacement of the hydraulic fluid is not generated at the wheel brake 28 and/or the wheel brake 30.

By means of the actuation of the brake pedal 12, a braking force demand is input, which must be matched by generation of a braking force. For this purpose, the drag torque originating from the electric machine 50 is utilized, which acts as a braking force on the moving system, in particular the vehicle wheel 200. If, for example, the braking force demand is covered by this generator braking force originating from the electric machine 50, the opening of the pressure dissipation valve 34 or 36 is performed to such an extent that no or substantially no hydraulic braking force acts at the associated wheel brake 28 or 30. If, for example, the braking force demand is higher than the generator braking force, the opening of the pressure dissipation valve 34 or 36 is performed such that, at the associated wheel brake 28 or 30, such a level of hydraulic braking force is built up, owing to the displacement of the hydraulic fluid, that the hydraulic braking force and the generator braking force give rise to an overall braking force which corresponds or at least approximately corresponds to the braking force demand.

After the activation of the pressure dissipation valve 34 or 36 or after the opening of the pressure dissipation valve 34 or 36, the associated isolation valve 22 or 24 is activated for closing by the control unit 48. This results in an adjustment of the associated isolation valve 22 or 24 from its open position (FIG. 1) in the direction of its closed position and thus to a shutting-off of the associated feed line 20.1 or 20.2. In this way, the associated wheel brake 28 or 30 is hydraulically isolated from the brake cylinder 16. Furthermore, the pump 38 is activated, for imparting a conveying action, by the control unit 48. As a result of the conveying action by the pump 38, a volume fraction of the hydraulic fluid that is still situated in the wheel brake 28 or 30 in question is conveyed out to such an extent that no braking force or substantially no braking force acts at the wheel brake 28 or 30 in question, in order that, in this way, the wheel brake 28 in question is placed in a hydraulically unpressurized state. When the actuation of the brake pedal 12 has been ended, the pressure dissipation valve 34 or 36 is activated for closing, and the associated isolation valve 22 or 24 is activated for opening. The pump 38 still imparts a conveying action until such time as the accumulator 42 has been evacuated.

Preferably, the control unit 48 is furthermore configured to, in the presence or upon an onset of an actuation of the brake cylinder 16, and in particular in the presence or upon an onset of a generator braking torque of the electric machine 50, activate one of the isolation valves 22, 24 for adjustment in the direction of a closed state in order to at least partially hydraulically isolate the associated wheel brake 28 or 30 from the brake cylinder 16 and thus adapt the two wheel brakes 28, 30 with regard to their braking force to an incipient or present wheel load distribution which is present in the motor vehicle during the course of the braking process. Preferably, the control unit 48 is configured to, in the presence or upon an onset of an actuation of the brake cylinder 16, and in particular in the presence or upon an onset of a generator braking torque of the electric machine 50, activate the isolation valve 24, which is assigned to the rear wheel brake 2, for adjustment in the direction of a closed state in order to at least partially hydraulically isolate the rear wheel brake 2 from the brake cylinder 16 and thus adapt the rear wheel brake 2 and the front wheel brake 1 with regard to their braking force to an incipient or present wheel load distribution of the motor vehicle during the braking process.

Preferably, the control unit 48 is furthermore configured to, in the presence of an actuation of the brake cylinder 16 and in particular in the presence of a generator braking torque of the electric machine 50, activate one of the isolation valves 22, 24 for adjustment in the direction away from the closed state in order to adapt the two wheel brakes 28, 30 with regard to their hydraulic braking force to a dynamic wheel load distribution which is encountered in the motor vehicle during the course of the braking process. Preferably, the control unit 48 is configured to, in the presence of an actuation of the brake cylinder 16 and in particular in the presence of a generator braking torque of the electric machine 50, activate the isolation valve 24, which is assigned to the rear wheel brake 2, for adjustment in the direction away from the closed state in order to adapt the front wheel brake 1 and the rear wheel brake 2 with regard to their hydraulic braking force to a dynamic wheel load distribution of the motor vehicle which is encountered during the course of the braking process and/or to a changing generator braking torque over the course of the braking process. For example, the control unit 48 is configured to, in the presence of an actuation of the brake cylinder 16, activate the isolation valve 24, which is assigned to the rear wheel brake 2, for adjustment in the direction away from the closed state in a manner dependent on a temporally changing generator braking torque of the electric machine 50 in order to adapt the front wheel brake 1 and the rear wheel brake 2 with regard to their hydraulic braking force to a dynamic wheel load distribution of the motor vehicle which is encountered during the course of the braking process.

In order to perform a regenerative braking process with hydraulic braking force action, the hydraulic brake system 10 may provide a mode of functioning which is described below on the basis of the example of the front wheel brake 1, which is assigned to a front wheel of the motor vehicle, and the rear wheel brake 2, which is assigned to a rear wheel of the motor vehicle: An actuation of the brake pedal 12 or an incipient actuation of the brake pedal 12 is identified or detected by the control unit 48 and, for example, the electric machine 50 is in the generator mode or a generator mode is incipient. The isolation valve 24 assigned to the rear wheel brake 2 is hereupon activated by the control unit 48 in order to adjust the isolation valve in the direction of a closed state and in this way at least partially hydraulically isolate the associated wheel brake 30 from the brake cylinder 16.

As a result of the actuation of the brake pedal 12, a displacement of a hydraulic fluid from the brake cylinder 16 in the direction of the front wheel brake 1 and of the rear wheel brake 2 is effected via the feed lines 20.1, 20.2. The displacement of the hydraulic fluid results in a higher hydraulic braking force at the front wheel brake 1 in relation to the rear wheel brake 2. An increased hydraulic vehicle braking torque is achieved in this way, because a focus is placed on the wheel load distribution of the motor vehicle that takes effect at least in the initial phase of the braking process. This braking situation is promoted in that the rear wheel 200 is additionally acted on by the generator braking torque provided by the electric machine 50.

In a manner dependent on the level of the generator braking torque, which changes in a manner dependent on the speed of the motor vehicle during the braking process, that is to say changes over the course of time or of the duration of the braking process, the isolation valve 24 is now activated by the control unit 48 for adjustment in the direction away from the closed state. As a result, a greater volume fraction of the hydraulic fluid flows into the rear wheel brake 2 or, if the isolation valve was fully closed beforehand, a volume fraction of the hydraulic fluid flows into the rear wheel brake 2 in the first place, and a compensation of volume of the hydraulic fluid can thus take place between the front wheel brake 1 and the rear wheel brake 2. Thus, the hydraulic braking force of the rear wheel brake 2 increases, and the hydraulic braking force of the front wheel brake 1 decreases.

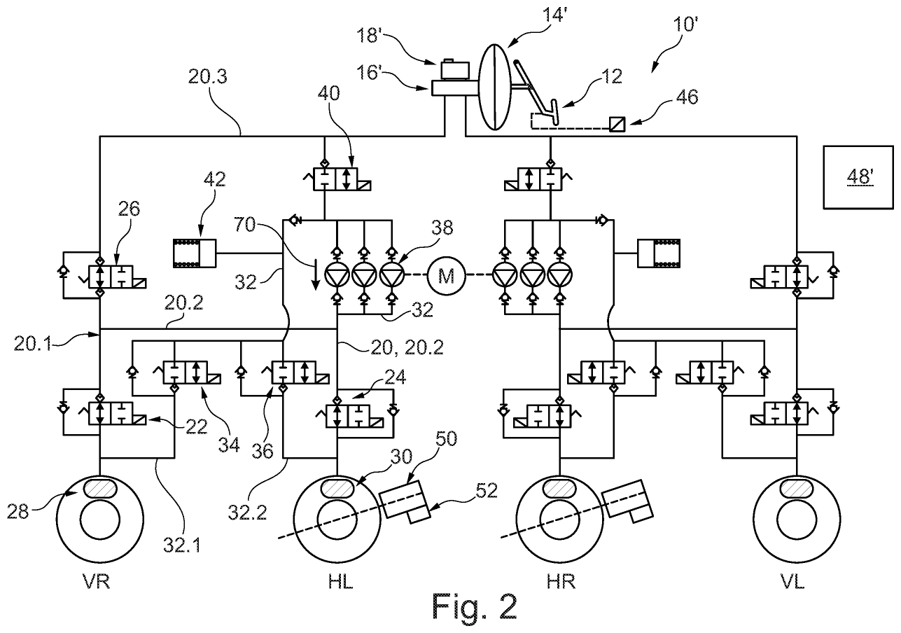

FIG. 2 shows a further possible embodiment of a hydraulic brake system 10′ which is suitable for performing a regenerative braking process and which may be used for example in a motor vehicle, in particular in a passenger motor vehicle or a heavy goods vehicle. The hydraulic brake system 10′ of FIG. 2 is a brake system as described in WO 2014/082885 A1. In this respect, with regard to the construction and the functionality of the hydraulic brake system 10′, reference is made to the disclosure of WO 2014/082885 A1, which is hereby incorporated in its entirety into the description.

In the hydraulic brake system 10′, by contrast to the hydraulic brake system 10 of FIG. 1, two brake circuits are provided, which are hydraulically separated from one another. There are preferably interactions between the two brake circuits. For example, a pressure equalization takes place via a common brake cylinder 16′, such that the same brake pressure prevails in both brake circuits. The brake cylinder 16′ is assigned a reservoir 18′ and/or a brake force booster 14′, wherein the reservoir 18′ and the brake force booster 14′ are dimensioned with regard to the two brake circuits. It is basically possible, in terms of function and/or construction, for the brake cylinder 16′ to correspond to the brake cylinder 16, for the reservoir 18′ to correspond to the reservoir 18, and for the brake force booster 14′ to correspond to the brake force booster 14 of the brake system 10 of FIG. 1.

Preferably, one of the brake circuits of the brake system 10′ is structurally identical and/or functionally identical to the one single brake circuit of the hydraulic brake system 10 of FIG. 1, such that components of the one brake circuit of the brake system 10′ are denoted by the same reference designations. In this respect, reference is made to the description relating to the brake system 10 of FIG. 1. Preferably, the two brake circuits of the brake system 10′ are of identical and/or functionally identical construction with respect to one another, such that, for the sake of simplicity and for better clarity, the other brake circuit has not been labelled with reference designations. For the sake of simplicity and for better clarity, any signal lines that are present have also been omitted in FIG. 2.

FIG. 2 illustrates four vehicle wheels, which are each assigned a wheel brake. The brake circuit under consideration comprises the wheel brakes 28 and 30, which are assigned in each case to a different vehicle wheel. The two vehicle wheels with the associated wheel brakes 28, 30 may be present at a common axle or may be assigned to different axles, for example to the front axle and to the rear axle of a motor vehicle.

FIG. 2 shows, by way of example, an assignment of the vehicle wheels to the front axle and to the rear axle in a diagonal configuration, wherein VR denotes the front right vehicle wheel, VL denotes the front left vehicle wheel, HR denotes the rear right vehicle wheel, and HL denotes the rear left vehicle wheel. By way of example, in FIG. 2, the electric machine 50 is assigned to the rear axle. The electric machine 50 interacts with the vehicle wheel at the rear left. For example, a further electric machine may be provided which interacts with the vehicle wheel at the rear right. It is also possible for the rear axle to be assigned an electric machine which is common to both vehicle wheels.

As can be seen from FIG. 2, the common line portion 20.3 of the feed lines 20.1, 20.2 may be assigned a further isolation valve 26. Furthermore, a supply valve 40 may be assigned to the common line portion 32.3 of the return lines 32.1, 32.2. By means of the supply valve 40, the return lines 32.1, 32.2 can be hydraulically connected, bypassing the further isolation valve 26, to a region positioned upstream of the isolation valve 26. The hydraulic brake system 10′ preferably comprises a control unit 48′ which is expanded in terms of its functional scope in relation to the control unit 48 of the hydraulic brake system 10 of FIG. 1 such that the further isolation valve 26 and the supply valve 40 can also be activated.

For example, the isolation valve 26 and the supply valve 40 are a constituent part of a driving dynamics control system (ESP). For example, the control unit 48′ is additionally configured for executing the hydraulic brake system 10′ during a driving dynamics control process. For example, the isolation valves 22, 24 and the pressure dissipation valves 34, 36 are a constituent part of an anti-lock braking system which is provided by means of the hydraulic brake system 10′. For example, the control unit 48″ is additionally configured for executing the hydraulic brake system 10′ during an anti-lock braking process.

In the present description, the expression “pressure dissipation valve” is to be understood in particular to mean a shut-off element by means of which the return line can be at least partially or fully opened, for example proceeding from a shut-off state. For example, the pressure dissipation valve has a passage for fluid, in particular the hydraulic fluid, which passage is of variable cross section. For example, the pressure dissipation valve is configured to be adjusted between a closed position and an open position, for example with regard to the passage, wherein, in the open position, the return line is at least partially or completely opened.

For example, the pressure dissipation valve is configured to be electrically or electromagnetically actuated, in order to be adjusted and/or switched, for example adjusted and/or switched in continuously variable or stepped and/or digital or analog fashion, between the closed position and the open position. For example, the pressure dissipation valve is or comprises a 2/2 directional valve; which, for example, assumes the closed position in a non-actuated state and the open position in an actuated state. If it is an electrically or electromagnetically actuated pressure dissipation valve, it is for example electrically deenergized in the non-actuated state and electrically energized in the actuated state. For example, the pressure dissipation valve is a valve with an NC function. The NC function is to be understood in particular to mean that the valve is closed in the electrically deenergized state. Such a valve may also be referred to as a “normally closed” NC valve. For example; the pressure dissipation valve is a preferably directly controlled solenoid valve with an NC function.

In the present description, the expression “pump” is to be understood in particular to mean a conveying device for conveying hydraulic fluid. For example, the pump is a rotary pump, in particular a radial piston pump or an axial piston pump. In particular, the rotary pump comprises at least one, preferably multiple, for example two to six, working piston(s), which perform(s) or can perform a reciprocating movement for the purposes of conveying the hydraulic fluid. For example, the pump comprises an electric machine, for example an electric motor, which serves for driving the pump. The electric machine is for example configured to receive electrical control signals and output corresponding control signals to the pump.

The expression “accumulator” is to be understood in particular to mean a hydro accumulator or hydraulic accumulator which is for example configured to store the hydraulic fluid under pressure. That volume fraction of the hydraulic fluid which is conducted to the accumulator is thus received therein counter to a resetting force of the accumulator. The accumulator may be designed such that a gas or a spring element is compressed during a process of filling with the hydraulic fluid. For example, the accumulator is a buffer accumulator which is configured to temporarily buffer-store the at least one volume fraction of the hydraulic fluid.

In the present description, the reference to a particular aspect or a particular embodiment or a particular refinement means that a particular feature or a particular characteristic described in conjunction with the respective aspect or the respective embodiment or the respective refinement is comprised at least therein but need not necessarily be comprised in all aspects or embodiments or refinements of the present disclosure. It is expressly pointed out that any combination of the various features and/or structures and/or characteristics described with regard to the present disclosure are encompassed by the present disclosure unless this is expressly or positively ruled out by the context.

The use of individual or all examples or of an exemplary phrasing in the text is intended merely to illustrate the present disclosure and does not constitute a limitation with regard to the scope of the present disclosure, unless stated otherwise. Also, no phrasing or wording of the description is to be understood as referring to an element which is not claimed but which is essential for the practical implementation of the present disclosure.

What is claimed is:

1. A method for controlling a hydraulic brake system during a regenerative braking process, wherein a hydraulic fluid is or has been displaced in the direction of at least two wheel brakes by means of a brake cylinder, and wherein at least one volume fraction of the hydraulic fluid is displaced between the at least two wheel brakes in order to adapt the at least two wheel brakes with regard to their hydraulic braking force to a changing wheel load distribution over the course of the braking process and/or to a changing generator braking torque over the course of the braking process.

2. A method for controlling a hydraulic brake system during a regenerative braking process, wherein, by means of a brake cylinder, a hydraulic fluid is displaced in the direction of at least two wheel brakes and one of the at least two wheel brakes is at least partially hydraulically isolated from the brake cylinder in order to adapt the at least two wheel brakes with regard to their hydraulic braking force to an incipient or present wheel load distribution.

3. The method as defined in claim 2, wherein an isolation valve is adjusted in the direction of a closed state in order to at least partially hydraulically isolate the one-wheel brake from the brake cylinder.

4. The method as defined in claim 3, wherein the isolation valve is adjusted into the closed state in order to fully hydraulically isolate the one-wheel brake from the brake cylinder.

5. The method as defined in claim 3, wherein, after the adjustment of the isolation valve in the direction of the closed state, the isolation valve is adjusted in the direction away from the closed state in order to relieve the other of the at least two wheel brakes of load with regard to its hydraulic braking force.

6. The method as defined in claim 1, wherein one of the at least two wheel brakes is a front wheel brake which is configured to be assigned to a front vehicle wheel, the other wheel brake is a rear wheel brake which is configured to be assigned to a rear vehicle wheel, and, in the regenerative braking process, a generator braking torque effected by an electric machine acts on the rear vehicle wheel.

7. The method as claimed in claim 2, wherein one of the at least two wheel brakes is a front wheel brake which is configured to be assigned to a front vehicle wheel, the other wheel brake is a rear wheel brake which is configured to be assigned to a rear vehicle wheel, and, in the regenerative braking process, a generator braking torque effected by an electric machine acts on the rear vehicle wheel, and wherein the at least partially hydraulically isolated wheel brake is formed by the rear wheel brake.

8. A hydraulic brake system for a motor vehicle, comprising:
a brake cylinder and at least two wheel brakes which are each hydraulically connected via a feed line to the brake cylinder, wherein the brake cylinder is configured to displace a hydraulic fluid in the direction of the at least two wheel brakes, and the at least two wheel brakes are configured to exert a hydraulic braking force by means of the hydraulic fluid;
an isolation valve which is fluidically assigned to one of the feed lines and which is configured to close the one feed line;
a control unit which is connected in signal-exchanging fashion to the isolation valve and which is configured to, in the presence or upon an onset of an actuation of the brake cylinder, and in particular in the presence or upon an onset of a generator braking torque of an electric machine, activate the isolation valve for adjustment in the direction of a closed state in order to at least partially hydraulically isolate the associated wheel brake from the brake cylinder and thus adapt the at least two wheel brakes with regard to their braking force to an incipient or present wheel load distribution.

9. The brake system as defined in claim 8, wherein the control unit is configured to, in the presence of an actuation of the brake cylinder and in particular in the presence of a generator braking torque of the electric machine, activate the isolation valve for adjustment in the direction away from the closed state in order to adapt the at least two wheel brakes with regard to their hydraulic braking force to a changing wheel load distribution over the course of the braking process and/or to a changing generator braking torque over the course of the braking process.

10. The brake system as defined in claim 8, wherein the control unit is configured to, in the presence of an actuation of the brake cylinder, activate the isolation valve for adjustment in the direction away from the closed state in a manner dependent on a change in the wheel load distribution and/or a changing generator braking torque.

11. The brake system as defined in claim 8, wherein one of the at least two wheel brakes is a front wheel brake, which is configured to be assigned to a front vehicle wheel, and the other wheel brake is a rear wheel brake, which is configured to be assigned to a rear vehicle wheel.

12. The brake system as defined in claim 11, wherein the isolation valve is a constituent part of an anti-lock braking system.
